(19) United States
(12) Patent Application Publication
(10) Pub. No.: US 2004/0126109 A1
(43) Pub. Date: Jul. 1, 2004

(54) Method for estimating bit-error-ratios within an optical communications network

(76) Inventor: John D. Downie, Painted Post, NY (US)

Correspondence Address: CORNING INCORPORATED, SP-TI-3-1, CORNING, NY, 14831

(21) Appl. No.: 10/677,450

(22) Filed: Oct. 2, 2003

Related U.S. Application Data
(60) Provisional application No. 60/437,290, filed on Dec. 31, 2002.

(51) Int. Cl. H04B 10/08

(52) U.S. Cl. 398/27

(57) ABSTRACT

A method for estimating the bit-error-ratio (BER) for a segment or whole of an optical communications network by measuring the actual distribution of bits (1s and 0s) in a transmitted data set as a function of threshold value, and directly estimating the BER at an optimal threshold value using a Q-fitting algorithm.

### BACKGROUND OF THE INVENTION

1. Field of the Invention

The present invention relates generally to monitoring and measuring data transmission integrity in optical communications networks, and particularly to methods for determining a bit error rate (BER) associated with the performance of such a network.

2. Technical Background

The integrity of signals transmitted via optical transmission systems are affected by optical noise within the system, and the gradual deterioration of the waveforms over distance. This deterioration results from a variety of sources, such as attenuation, chromatic and polarization-mode dispersion, nonlinearities, and other effects.

The design and operation of an optical network (particularly one employing amplification, multiple optical fiber links, dispersion compensation, and routing switches) requires maintaining an acceptable margin between the actual signal-to-noise (SNR) ratio at any point in the network and a threshold ratio determined by the maximum acceptable bit-error-rate(BER) or bit error ratio for the overall network. It may be difficult or impractical to measure actual SNRs or BERs associated with specific optical functions or regions within a network, due to the type of equipment that would need to be deployed remotely throughout the network, and the time necessitated to precisely or reliably determine these values at very low BERs.

Various approaches for determining the BER at locations within a network are currently used. In general, conventional methods rely either on transmitting a known data set (for example, a pseudo-random string of 1s and 0s) via the network and comparing the received content with the original content at specific points of inquiry, or conversely appending a parity value to an actual data set (the parity value being calculated using the content of the data set and some predetermined algorithm), in which case the magnitude of any variation between the original parity value and one calculated using the received data set is proportional to the BER for that transmission span. It will be appreciated that these approaches present limitations or drawbacks, such as fractionally reducing the network's bandwidth capacity for true information content due to the overlay of parity or integrity-checking content, and being highly-dependent on the network's signal format (SONET, SDH, PDH, etc.)

Approaches for estimating BER more conveniently at remote locations within a network, independent of signal format, and without informational overlay have been proposed. One approach involves measuring BER experimentally at a range of decision threshold values, and then extrapolating to estimate a minimum-achievable BER at the optimal threshold. This process involves using a Q-fitting algorithm, and the technique may be illustrated graphically by plotting a two-dimensional histogram of the log(BER) signal values along they-axis and the threshold value (usually in mV) along the x-axis to form two converging lines of data points, fitting curves to those data points, and extrapolating the point at which the curves intersect. Such a process relies on various assumptions (such as the noise within the system being Gaussian, which in not strictly true), but has yielded reasonably accurate BER estimates for some applications.

A further description of implementations of such BER-estimation processes and the relevant calculations and algorithms involved are provided by Bergano, et al., Margin Measurements in Optical Amplifier Systems, IEEE Photonics Tech. Letters, vol. 5, no. 3, pp.304-306 (October 1993), and Ohteru, et at., Optical Signal Quality Monitor Using Direct Q-Factor Measurement, IEEE Photonics Tech. Letters, vol. 11, no. 10, pp. 1307-1309 (October 1999).

### SUMMARY OF THE INVENTION

In overview, the present invention involves using a bit counter to measure the actual distribution of 1s and 0s in a transmitted data set (measured within a predetermined synchronous time frame) as a function of threshold value, and directly estimate the BER at an optimal or predetermined threshold value using a Q-fitting algorithm.

Additional features and advantages of the invention will be set forth in the detailed description which follows, and in part will be readily apparent to those skilled in the art from that description or recognized by practicing the invention as described herein, including the detailed description which follows and the claims.

It is to be understood that both the foregoing general description and the following detailed description merely present representative embodiments of the invention, and are intended to provide an overview or framework for understanding the nature and character of the invention as it is claimed. These particular embodiments are merely representative, and assist in a full understanding of the invention as it is contemplated as a whole, but are not intended to define or limit the scope or boundaries of that invention as it is to be understood and appreciated.

### DETAILED DESCRIPTION OF THE PREFERRED EMBODIMENTS

The method of the present invention is described herein by reference to representative embodiments which are set forth in detail. In general, the present invention involves using a signal-quality monitor to measure the actual distribution of Is and 0s that are transmitted in a data set over a selected span within an optical network as a function of threshold value for a decision circuit, and directly estimating the BER at an optimal or predetermined threshold value using a Q-fitting algorithm.

The selected span may be across a single component or module for purposes of discrete optical performance testing or monitoring, a specified link within a larger network (such as an amplifier-to-amplifier or regenerator-to-regenerator span), or an entire network pathway from initial transmitter to ultimate receiver including multiple intervening links and nodes. Monitoring may be performed using a single channel or multiple channels within a wavelength-division multiplexed (WDM) network.

In the representative embodiments described herein, the distribution of 1s and 0s that are transmitted in a data set are measured using a predetermined time frame relative to a clock recovery signal, and as such may be referred to as synchronous implementations. It may be appreciated that asynchronous implementations of this method may also be utilized in appropriate applications.

In a synchronous implementation, the signal-quality monitor may be one of a number of conventional designs disclosed in the art. For example, a suitable minimal design incorporates an input signal transmitted over an optical fiber, an optical-to-electronic transition such as a photodetector, an electronic signal gain amplifier if necessary, a decision circuit in which the threshold voltage may be selectively varied, a bit counter which may be reset as threshold values are incremented, a clock circuit which produces a timing signal, a memory to retain bit counts associated with each threshold value, and a processor to calculate a Q-factor from the recorded data. The operation of the decision circuit and bit counter are correlated to the timing signal generated by the clock circuit. Output values to the memory and processor include the measured number of ones, zeros, and total bits at each specified threshold voltage (vᵢ)—N₁(vᵢ), N₀(vᵢ), and N_{T}(vᵢ), respectively—and may include other parameters depending on the complexity and functionality of the system.

It is understood that in some implementations, both structural and functional alternatives or equivalents to these elements may be utilized. It will further be appreciated that the selection of specific optical and electronic elements for performing the corresponding functions will depend upon several competing design considerations intrinsic to the system itself, and influenced by the design and performance of the optical communications network within which the system is placed, as well as the preferences of and particular technologies available to those in the art when practicing the present invention. It is understood that the description of the optical and electronic functionality of these elements as set forth herein is sufficient for those in the art to select from among readily-available alternates for these optical elements as functional and pragmatic considerations dictate, with reference to the literature available to those in the art including the references identified above, and this invention further permits the adoption of new technologies suitable for performing these optical and electronic functions that may hereafter be developed or refined.

If the measured number of 1s at a threshold value v is designated as N₁(vᵢ)^{m}, and the measured number of 0s at the threshold value vᵢ is designated as N₀(Vᵢ)^{m}, it follows that N_{T}(vᵢ)=N₁(vᵢ)^{m}+N₀(vᵢ)^{m}. If the actual number of 0s transmitted during a predetermined time frame or gating period is designated as N₀(vᵢ)^{trans}, then if follows that BER(vᵢ)=|N₀(vᵢ)^{trans}−N₀(vᵢ)^{m}|/N_{T}(vᵢ). Two theoretical assumptions underlying the present invention are that the number of 1s and 0s transmitted within the given time interval are equal, and that errors result exclusively from the detection perception of true 1s as 0s and true 0s as 1s. These assumptions are understood to be valid for normal network transmissions carrying telephonic, data, or Internet information given a sufficiently-long gating interval, and for measurements taken at threshold values sufficiently separated from the optimal threshold value.

Given the above assumptions, it is possible to substitute N_{T}(vᵢ)/2 for N₀(vᵢ)^{trans} to yield BER(vᵢ)=|N_{T}(vᵢ)/2−N₀(vᵢ)^{m}|/N_{T}(vᵢ) in place of the equation above.

In certain applications, it is expected that BER measurements as a function of the decision threshold value will need to be taken for several different time phase values (that is, different time delays relative to the clock circuit's timing signal), and as such the process of searching through both a phase space (or range) as well as a threshold space (or range) for the optimal threshold value may be implemented in a manner paralleling the conventional approaches to such calculations but employing as a subset the method of this invention. A minimum BER value and optimal threshold value would be calculated for each time phase (or delay), and would entail a similar curve-fitting process and relating or plotting minimum BER against phase in order to estimate the optimal phase. Such a two-step process producing estimates comprising optimal decision time phase, decision threshold, and minimum BER will thereby yield the desired result for an optimal threshold value.

It should be recognized from a theoretical perspective that an imbalance in the actual numbers of 1s and 0s transmitted during a given gating interval may be expressed as N₀(vᵢ)^{trans}=(1±δ) N_{T}(vᵢ)/2 wherein δ represents the fractional deviation from balance and δ<<1. This understanding yields a relationship between the calculated BER (BER_{calc}) and real BER (BERᵣₑₐₗ) which may be simply expressed using the equation BER_{calc}(vᵢ)=BERᵣₑₐₗ(vᵢ)±δ/2. From this, it will be readily appreciated that for many implementations of the method of the present invention, the condition δ/2<<BERᵣₑₐₗ(vᵢ) should or must be maintained.

The extent or degree to which the condition δ/2<<BERᵣₑₐₗ(vᵢ) should or must be maintained for a given optical network will vary depending on several parameters associated with the network architecture, integrity constraints related to the type of informational content being transmitted, operating and performance characteristics of optical fiber, modules, and components utilized in the network, as well as the preferences of those designing and operating the network. As such, it is anticipated that the impact of variations will be simulated and evaluated on a case-by-case basis using conventional modeling techniques, and choices made regarding the exact implementation of the present method based upon those prevailing factors and the results of modeling.

As noted above, the assumption regarding an equal balance between the numbers of transmitted 1s and 0s depends upon the lowest BER value to be measured in order to perform the Q-fitting algorithm. So, for example, if BER measurements were to be taken from values in the range of 10⁻³ down to 10⁻¹⁰, then the degree to which the assumption must hold true may be approximated as one part in 10¹⁰. Conversely, if BER measurements were only to be taken down to 10⁻⁷, then the accuracy of the balance assumption need only hold true to approximately one part in 10⁷. It is expected that in many conventional networks, BER measurements down to 10⁻⁷ or 10⁻⁸ should suffice for performing accurate Q-fitting analyses, and allow gating intervals on the order of one second or less.

It will be readily appreciated that the Q-factor, which is normally defined as the SNR at the decision circuit in either voltage or current units, may be expressed using the equation Q=|μ₁−μₒ|/(σ₁−σ₀) where μ₁, μₒ represent mean values and σ₁, σ₀ represent standard deviations. While Q may be measured directly using a sampling oscilloscope, it does not provide a good correlation to BER for reasons well known to those in the art. However, given the assumption of fitting data to a Gaussian characteristic, the BER at a selected decision level v may evaluated using a conventional Q-fitting algorithm expressed as:

$$BER ( {v}_{i} ) = \frac{1}{2} \{ erfc ( \frac{\vert {μ}_{1} - {v}_{i} \vert}{{σ}_{1}} ) + erfc ( \frac{\vert {μ}_{0} - {v}_{i} \vert}{{σ}_{0}} ) \}$$

in which erfc(x) is a complementary error function expressed as:

$$erfc ( x ) = \frac{1}{\sqrt{2 π}} {\int }_{x}^{∞} {ⅇ}^{- 2 β 2 / 2} \partial β$$

and is therefore≈

$$\frac{1}{x \sqrt{2 π}} {ⅇ}^{x 2 / 2}$$

Various changes, adaptations, and modifications may be made to the present invention as represented by the exemplary embodiments described herein without departing from the spirit and scope of the invention as understood and recognized. Thus, it is intended that the present invention cover the modifications, adaptations, and variations to this invention provided they come within the scope of the appended claims and their equivalents.

What is claimed is:

1. A method for estimating the bit-error-ratio (BER) within an optical communications network via which a multiplicity of information-carrying data bits are transmitted over an optical medium, each of the multiplicity of information-carrying data bits being designated in nomenclature as either ones or zeros, the method comprising the steps of:
extracting a sequence containing a finite number of the data bits from among that multiplicity of information-carrying data bits;
transmitting the sequence to a decision circuit capable of discriminating the finite number of data bits as either ones or zeros as a function for a threshold value;
setting the threshold value;
counting at least a number of ones and a number of zeros associated with the finite number of data bits in the sequence at the threshold value;
repeating the steps of setting the threshold value and counting at least the number of ones and the number of zeros associated with the finite number of data bits in the sequence at the threshold value for a plurality of different threshold values to establish a plurality of data sets, each data set reflecting at least the number of ones and the number of zeros measured as corresponding to the threshold value; and
estimating an optical BER value by performing a Q-fitting algorithm on the plurality of data sets.

2. The method of claim 1 wherein the Q-fitting algorithm is characterized by the formula
$$BER ( {v}_{i} ) = \frac{1}{2} \{ erfc ( \frac{\vert {μ}_{1} - {v}_{i} \vert}{{σ}_{1}} ) + erfc ( \frac{\vert {μ}_{0} - {v}_{i} \vert}{{σ}_{0}} ) \}$$
wherein erfc represents a complementary error function, μ₁ and μₒ represent mean values, and σ₁ and σ₀ represent standard deviations.

3. The method of claim 2 wherein the complementary error function is expressed by the formula
$$erfc ( x ) = \frac{1}{\sqrt{2 π}} {\int }_{x}^{∞} {ⅇ}^{- 2 β 2 / 2} \partial β .$$

4. The method of claim 3 wherein the complementary error function is approximately equal to
$$\frac{1}{x \sqrt{2 π}} {ⅇ}^{x 2 / 2} .$$

5. The method of claim 1 wherein at least the step of extracting a sequence containing a finite number of the data bits from among that multiplicity of information-carrying data bits is performed synchronously.

6. The method of claim 1 wherein the steps are preformed synchronously.

7. The method of claim 1 wherein at least the step of extracting a sequence containing a finite number of the data bits from among that multiplicity of information-carrying data bits is performed asynchronously.

8. The method of claim 1 wherein the steps are preformed asynchronously.
